(19) United States
(12) Patent Application Publication
(10) Pub. No.: US 2017/0018021 A1
(43) Pub. Date: Jan. 19, 2017

(54) METHOD OF FACILITATING A USER IN SELECTION OF ARTICLES IN A RETAIL ENVIRONMENT AND A SYSTEM THEREOF

(71) Applicant: MOONRAFT INNOVATION LABS PVT. LTD., Bangalore (IN)

(72) Inventors: Ankit SHEKHAWAT, Bangalore (IN); Kumar Rishi Anand, Bangalore (IN); Vikas Johiya, Bangalore (IN); Purva Sharma, Bangalore (IN)

(73) Assignee: MOONRAFT INNOVATION LABS PVT. LTD., Bangalore (IN)

(21) Appl. No.: 15/209,546

(22) Filed: Jul. 13, 2016

(30) Foreign Application Priority Data
Jul. 13, 2015 (IN) 3568/CHE/2015

(51) Int. Cl. G06Q 30/06

(52) U.S. Cl. CPC G06Q 30/0631

(57) ABSTRACT

Disclosed herein is a method and system for facilitating a user in selection of articles in a retail environment. Information related to the articles is received from one or more first data sources. The user related information is retrieved from one or more second data sources. Further, an analysis report is generated based on information related to the articles and the user related information. Finally, the analysis report, having one or more recommendations, is provided to the user, thereby facilitating the user in selection of articles. The method disclosed hereinabove aims at minimizing the total time taken by the user in selecting and purchasing a particular article of interest to the user, since the one or more real-time recommendations are provided to the user. The method also prevents the user from purchasing articles that are out-of-fashion based on the current trends associated with the articles.

### CROSS-REFERENCE TO RELATED APPLICATION

The present application claims priority under 35 U.S.C. §119 to Indian Patent Application No. 3568/CHE/2015, filed Jul. 13, 2015, the entirety of which is hereby incorporated by reference.

### TECHNICAL FIELD

The present subject matter is related, in general to data analytics, and more particularly, but not exclusively to a method and system for facilitating a user in selection of articles based on data analytics.

### BACKGROUND

Technology has changed the way in which consumers/users shop for products and services at present. Due to the development of online shopping websites and of smartphones that are capable of performing searches to research for products, consumers are less inclined towards in-store/retail store shopping services. The online shopping experience does not provide the ability for the consumers to adore the feel of a desired product. Hence, in-store/retail shopping services are vital for providing real-time experience for the consumers while purchasing a product.

However, while purchasing a product in the retail environment, the consumers may end-up purchasing a product which is out of fashion since the consumers may not know the latest trends in the retail environment. Also, the consumers may fail to make wiser decisions while purchasing a product since the consumers may not be aware of what best suits a particular product. For example, a consumer who has entered a cloth shop may find it difficult to select a matching shirt for a jeans trouser liked by him, thereby ending up in making an inappropriate selection.

The existing arts for enhancing the consumer experience in a retail shopping environment do not provide convenient means for identifying the appropriate alternatives and/or varieties of a selected product. For example, in the retail cloth shop, the consumers may not have an option to visualize the clothing that would match with a selected cloth. Instead, the consumer may have to try all clothing to find a perfect match for the selected cloth, which can be tedious and time consuming. Further, the consumers may also want to know whether the product being purchased in the retail shop is good or bad. Also, certain consumers may need an expert opinion in selecting and purchasing a better product in the retail store. At present, there is no clear-cut solution and/or mechanism for providing this information to the consumers in the retail environment.

The challenges mainly faced in facilitating a user in selection of the articles includes retrieving information related to the one or more articles and the user, and generating an analysis report for providing one or more real-time recommendations to the user.

### SUMMARY

The present disclosure relates to a method of facilitating a user in selection of articles in a retail environment, the method comprises receiving, by a decision support system, information related to one or more articles, selected by a user, from one or more first data sources. The method also comprises retrieving user related information from one or more second data sources associated with the decision support system. Thereafter the method generates an analysis report based on the information related to the one or more articles selected by the user and the user related information. Finally the analysis report is provided to the user through a user interface associated with decision support system for facilitating the user in selection of the one or more articles.

Further, the present disclosure relates to a decision support system for facilitating a user in selection of articles in a retail environment. The decision support system comprises a processor and a memory communicatively coupled to the processor, wherein the memory stores processor-executable instructions, which, on execution, causes the processor to receive information related to one or more articles, selected by a user, from one or more first data sources. The instructions further cause the processor to retrieve user related information from one or more second data sources associated with the decision support system. Thereafter an analysis report is generated based on the information related to the one or more articles selected by the user and the user related information. Finally the decision support system provides the analysis report to the user through a user interface associated with decision support system for facilitating the user in selection of the one or more articles.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1A shows an exemplary environment illustrating a decision support system for facilitating a user in selection of one or more articles in accordance with some embodiments of the present disclosure;

FIG. 1B shows a detailed block diagram illustrating the decision support system in accordance with some embodiments of the present disclosure;

FIG. 1C shows exemplary structure of a user interface associated with the decision support system in accordance with some embodiments of the present disclosure;

FIGS. 2A-2C illustrate exemplary structure of the user interface associated with the decision support system in accordance with few embodiments of the present disclosure;

FIG. 3 shows a flowchart illustrating a method for facilitating the user in selection of the one or more articles in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Disclosed herein is a method and decision support system for facilitating a user in selection of one or more articles. The decision support system collects information related to the one or more articles selected by the user from one or more first data sources associated with the decision support system. As an example, the information related to the one or more articles may include, without limiting to, price of the one or more articles, one or more physical and/or qualitative properties of the one or more articles, one or more feedbacks, comments and user ratings for the one or more articles. In an embodiment, the one or more first data sources may include, not limiting to, a barcode identification tag associated with the one or more articles, Radio Frequency Identification (RFID) tag associated with the one or more articles and information on social media networks related to the one or more articles. Further, the decision support system collects information related to the user from one or more second data sources including, without limiting to, social media profile of the user and retail store membership and/or other identification cards of the user. As an example, the user related information may include, without limitation, social media activities of the user, article purchase history of the user and interests and personal details of the user.

In an embodiment, the decision support system may generate an analysis report based on the information related to the one or more articles and the user related information that are collected from the one or more first data sources and second data sources respectively. In one example, the analysis report may comprise one or more recommendations for facilitating the user in selection of the one or more articles. As an example, the one or more recommendations are at least one of information related to one or more articles matching with the one or more articles selected by the user, information related to current trends and quality of the one or more articles selected by the user. In one implementation, the one or more recommendations are provided to the user using a user interface associated with the decision support system.

In an embodiment, the one or more recommendations provided to the user enables the user for selecting one or more articles having better quality and/or better user ratings than the one or more articles selected by the user as per the current trends in the one or more articles, thereby preventing the user from purchasing one or more articles that are outdated and/or out-of-fashion. The decision support system may also minimize the total time taken by the user for selecting and purchasing a particular article of interest, since the one or more real-time recommendations are provided to the user.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

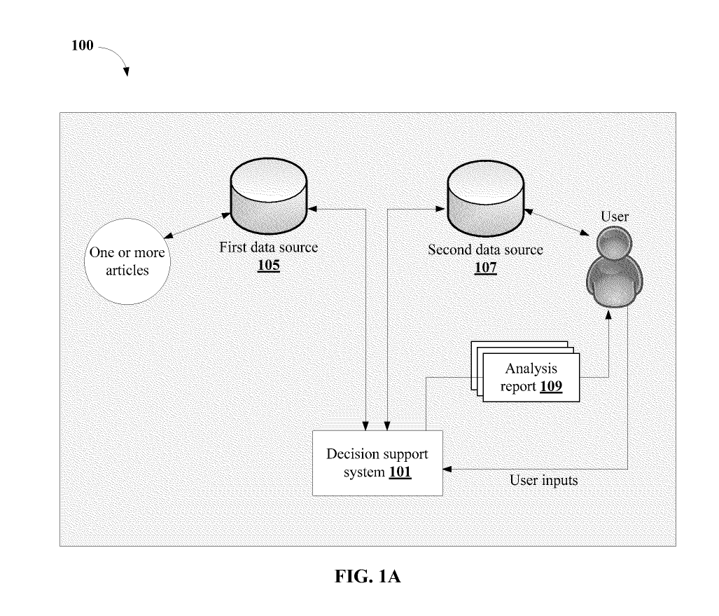

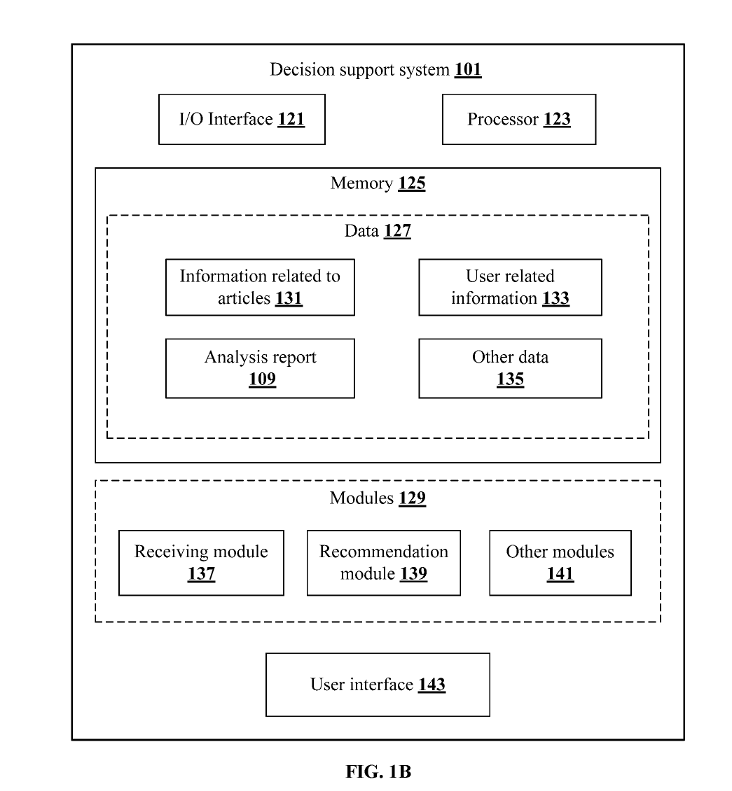

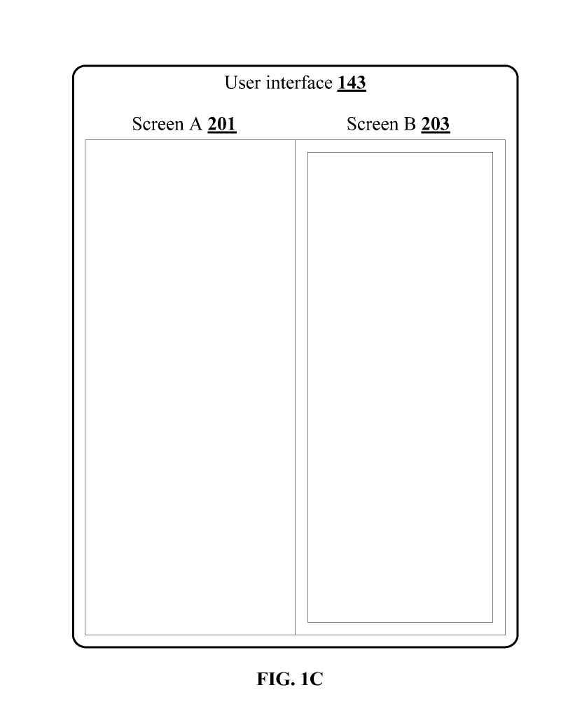

FIG. 1A shows an exemplary environment illustrating a decision support system for facilitating a user in selection of one or more articles in accordance with some embodiments of the present disclosure.

The exemplary environment 100 includes a user, one or more articles and a decision support system 101. In an embodiment, the decision support system 101 may receive information related to the one or more articles 131 selected by the user from one or more first data sources 105 including, but not limited to, a barcode associated with the one or more articles, RFID tag associated with the one or more articles and social media networks associated with the one or more articles. The information related to the one or more articles 131 may include, without limiting to, price of the one or more articles, properties of the one or more articles, feedbacks and ratings of the one or more articles. For example, if the article selected by the user is a cloth, then the information related to the cloth may include properties such as color of the cloth, brand name of the cloth, size of the cloth etc. Further, the decision support system 101 may retrieve information related to the user 133 (referred as user related information 133 hereinafter) form one or more second data sources 107 associated with the decision support system 101. As an example, the user related information 133 comprises at least one of social media activities of the user, purchase history of the user and interests and personal details of the user. In an implementation, the decision support system 101 may update the one or more second data sources 107 at one or more predefined time intervals, for example once in a day, based on the purchase history of the user, thereby keeping the one or more second data sources 107 up-to-date with the interests and purchase habits of the user.

In an embodiment, upon receiving the information related to the one or more articles 131 and the user related information 133, the decision support system 101 may generate an analysis report 109 to be provided to the user. The analysis report 109 provided to the user may include one or more recommendations for facilitating the user in selection of the one or more articles. As an example, the one or more recommendations are at least one of information related to one or more articles matching with the one or more articles selected by the user, information related to current trends and quality of the one or more articles selected by the user. Accordingly, the user may consider the one or more recommendations in the analysis report 109 for making a better selection of the one or more articles.

FIG. 1B shows a detailed block diagram illustrating the decision support system in accordance with some embodiments of the present disclosure.

The decision support system 101 comprises an I/O interface 121, a processor 123 and a memory 125. The I/O interface 121 is configured to receive the information related to the one or more articles 131 and the user related information 133 from the one or more first data sources 105 and the one or more second sources respectively. The memory 125 is communicatively coupled to the processor 123. The processor 123 is configured to perform one or more functions and operations of the decision support system 101 for facilitating the user for selection of the articles. In one implementation, the memory 125 of the decision support system 101 comprises data 127 and modules 129 for performing various operations in accordance with the embodiments of the present disclosure. In an embodiment, the data 127 may include, without limiting to, the information related to the articles, the user related information 133, the analysis report 109 and other data 135.

In one embodiment, the data 127 may be stored within the memory 125 in the form of various data structures. Additionally, the aforementioned data 127 can be organized using data models, such as relational or hierarchical data models. The other data 135 may store data, including temporary data and temporary files, generated by modules 129 for performing the various functions of the multimedia content generator 101.

In an embodiment, the information related to the one or more articles 131 are the one or more details pertaining to the one or more articles. The information related to the one or more articles includes 131, without limiting to, price of the one or more articles, properties of the one or more articles, feedbacks and ratings of the one or more articles. As an example, the feedbacks and user ratings associated with the one or more articles may be used to understand the usefulness, reliability and popularity of the one or more articles. In an embodiment, the decision support system may use these feedbacks and user ratings to identify one or more articles having low user ratings, in order to notify the user when the user selects an article having low user rating. In an embodiment, the information related to the one or more articles 131 may be received from one or more first data sources 105 associated with the decision support system 101. The one or more first data sources 105 may include, without limiting to, a barcode associated with the one or more articles, RFID tag associated with the one or more articles and social media networks.

In an embodiment, the user related information 133 comprises one or more details related to the user. The one or more user related information 133 may include, without limiting to, social media activities of the user, purchase history of the user and interests and personal details of the user. For example, the one or more social media activities of the user may be used to understand the interests, favorites (favorite color, favorite brands, eating habits etc.) and personal details (age, gender etc.) of the user. Similarly, the purchase history of the user may be used to understand the user's inclination towards a particular brand and/or nature of products that fascinate the user. In an embodiment, the user related information 133 may be retrieved from the one or more second data sources 107 associated with the decision support system 101.

In an embodiment, the analysis report 109 may comprise one or more recommendations for facilitating the user in selection of the one or more articles. The one or more recommendations includes, without limiting to, information related to the one or more articles 131 matching with the one or more articles selected by the user, information related to current trends and quality of the one or more articles selected by the user. In an embodiment, the analysis report 109 having the one or more recommendations to the user may be displayed and/or provided to the user on the user interface 143 associated with the decision support system 101.

In an embodiment, the data 127 may be processed by one or more modules 129 of the decision support system 101. In one implementation, the one or more modules 129 may also be stored within the memory 125. In an example, the one or more modules 129 may be communicatively coupled to the processor 123 for performing one or more functions of the decision support system 101. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 129 may include, without limitation, a receiving module 137, a recommendation module 139 and other modules 141. The other modules 141 may be used to perform various miscellaneous functionalities of the decision support system 101. It will be appreciated that such aforementioned modules may be represented as a single module or a combination of different modules

In an embodiment, the receiving module 137 may be configured to receive the information related to the one or more articles 131 selected by the user, from the one or more first data source 105 associated with the decision support system 101. Similarly, the receiving module 137 may also be configured for receiving the user related information 133 from the one or more second data source 107 associated with the decision support system 101.

In an embodiment, the recommendation module 139 may be configured for generating an analysis report 109 to facilitate the user for selecting the one or more articles. As an example, the one or more recommendations includes, without limiting to, information related to the one or more articles 131 matching with the one or more articles selected by the user, information related to current trends and quality of the one or more articles selected by the user. In an implementation, the analysis report 109 generated by the recommendation module 139 is provided to the user using the user interface 143 as explained in the below sections.

FIG. 1C shows an exemplary structure of the user interface 143 associated with the decision support system 101 in accordance with some embodiments of the present disclosure. As shown in FIG. 1C, the user interface 143 may have one or more partitions (represented as Screen A 201 and Screen B 203 in FIG. 1C) for displaying the analysis report 109 and/or for receiving one or more inputs from the user. In an embodiment, the one or more articles selected by the user may be placed on Screen A 201 for retrieving information related to the one or more articles 131 selected by the user. Screen A 201 may be configured with one or more information retrieval techniques such as, a barcode scanner, a RFID scanner and one or more audio/video sensing techniques that are capable of retrieving information related to the one or more articles 131 placed on Screen A 201. Alternatively, Screen A 201 may also be configured with a touchscreen/touchpad interface for receiving one or more inputs from the user. As an example, the user may provide one or more personal details viz. name, gender, login information, locality information etc. to the decision support system 101 using the touchscreen interface configured on Screen A 201.

In an embodiment, Screen B 203 may be configured to display the analysis report 109 to the user. Screen B 203 may also be used for displaying information related to the one or more articles 131 selected by the user, (which are placed on Screen A 201) and the user related information 133. Further, Screen B 203 may be configured to display the details and/or images of the one or more matching articles having similar features as compared with the one or more articles selected by the user and placed on Screen A 201. The structure of the user interface 143 shown in FIG. 1C is a generic representation and may vary based on the nature of the one or more articles and/or nature of the retail store in which the decision support system 101 is deployed.

### Scenario 1: Decision Support System Deployed at a Clothing Retail Store.

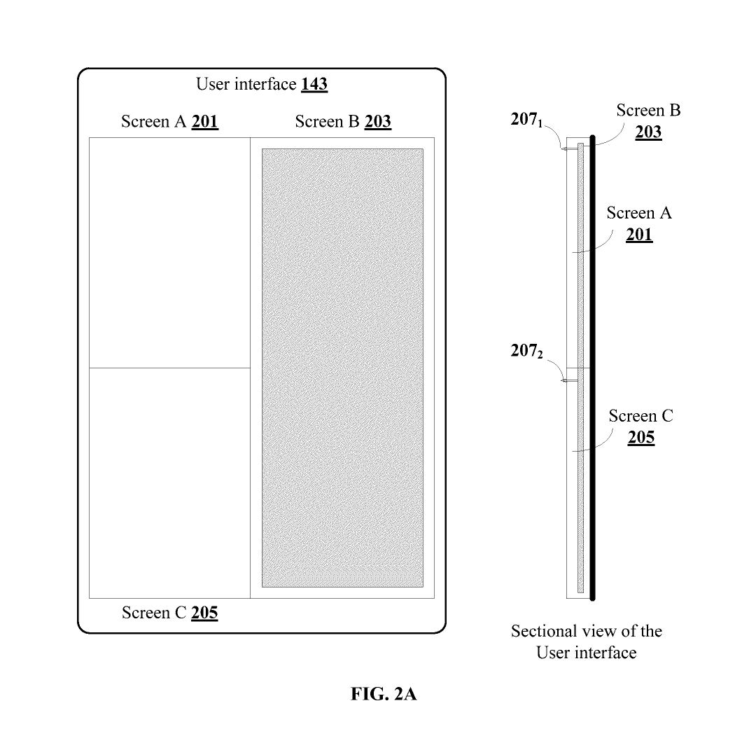

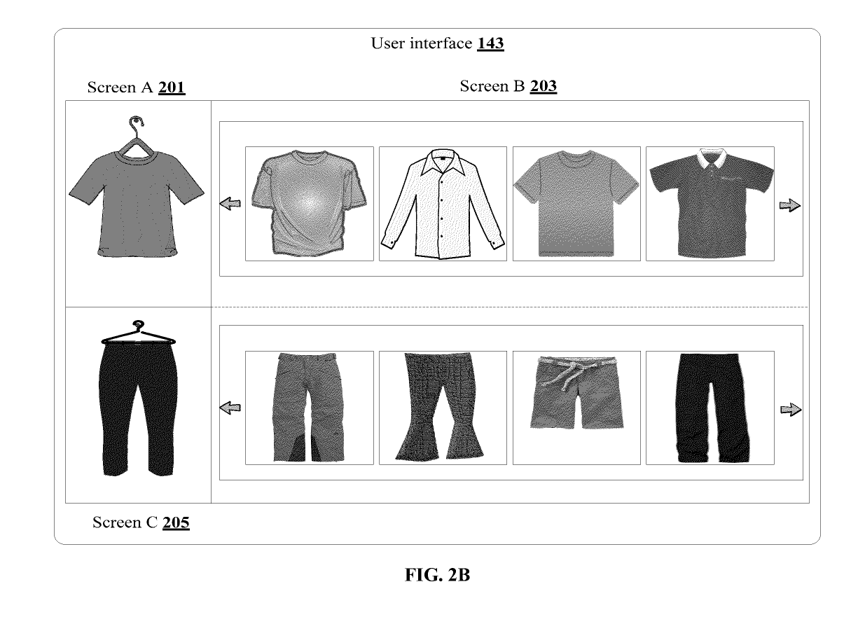

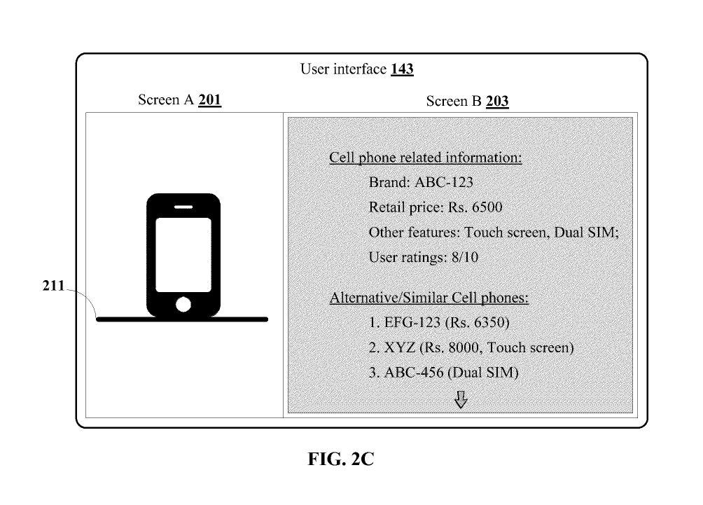

FIGS. 2A and 2B shows exemplary representations of the user interface 143 associated with the decision support system 101 deployed in a clothing retail store. Accordingly, the user interface 143 at the clothing retail store may be partitioned into three distinct parts as represented by Screen A 201, Screen B 203 and Screen C 205 in FIG. 2A. In an embodiment, Screen A 201 may be used to place/hang a piece of cloth such as, a shirt, a jacket, a blazer suit etc. which are of interest to the user. Similarly, Screen C 205 may be used to place/hang one or more cloths, corresponding to the cloth hung on Screen A 201, cloths such as, a trouser, a short-pant etc. that the user wishes to purchase along with the cloth placed on Screen A 201. Now, the receiving module 137 may collect information related to the selected cloths (which are placed on Screen A 201 and Screen B 203) from the one or more first data sources 105 associated with the selected cloths. In this scenario, the receiving module 137 may receive the information related to the selected cloths from a barcode tag attached to each of the selected cloths. Now, the recommendation module 139 generates the analysis report 109 based on the information related to the selected cloths and the user related information 133. As an example, the user related information 133 that are considered in this scenario may include one or more favourite colours of the user, favourite wear/clothing attire of the user etc.

The one or more recommendations comprised in the analysis report 109 may be displayed to the user through Screen B 203 on the user interface 143. In the current scenario, the one or more recommendations provided to the user may include price details of the selected cloths, images/previews of one or more cloths that match with the selected cloths and images/previews of one or more cloths that are most popular as per the current trend of clothing. Additionally, the one or more recommendations may also suggest the user whether or not the cloths placed on the Screen A 201 and Screen B 203 are a good match to each other, if the user intends to wear both the cloths together.

FIG. 2A also shows a sectional view of the user interface 143 used in the clothing retail shop. In an embodiment, Screen A 201 and Screen C 205 may be made of a transparent material such as glass having a means for placing/hanging the cloths selected by the user as indicated by 207₁ and 207₂. Further, Screen B 203 may be a display screen made of an appropriate material such as Liquid Crystal Display (LCD) or a Light Emitting Diode (LED) display.

FIG. 2B shows an exemplary view of the user interface 143 at the clothing retail store. As explained in the above scenario, the user may select a shirt of his/her choice and place it on Screen A 201. Thereafter, the user may select a trouser which may be placed on Screen C 205. Now, the decision support system 101 may collect all possible information related to the user and the information related to the cloths placed on Screen A 201 and Screen C 205 for facilitating the user in selection of a best pair of cloth and/or a best match to the cloths placed on Screen A 201 and Screen C 205. As an example, Screen B 203 shows one or more cloths having similar design, price range and colour variations that may be suggested to the user based on the user's initial selection of cloths. Thus, the decision support system 101 deployed at a clothing store eliminates the need for wearing and/or checking each combination of cloths while purchasing a cloth of interest to the user.

In an embodiment, the analysis report 109 and/or the one or more recommendations to the user may be provided on one or more user devices (computing devices associated with the users) such as, a smartphone, a Personal Digital Assistant (PDA) device etc. associated with the user. As an example, the decision support system 101 may push a dynamic update, such as a browser software application, into the one or more user devices in order to enable each of the one or more user devices to receive the analysis report 109 and/or the one or more recommendations, as soon as the user enters the retail environment. In an implementation, the decision support system 101 may be further configured with one or more data/file sharing techniques such as Near Field Communication (NFC), in order to automatically push these dynamic updates/software applications into the one or more user devices, based on location of the one or more user devices. Further, the dynamic updates/software applications that have been pushed (and installed) into the one or more user devices may be automatically removed/un-installed from the one or more user devices once the user moves out of the retail store and/or after a predetermined time period, say 2 hours, to make sure that the user devices remain unaffected.

Accordingly, the user may refer to the analysis report 109 and/or the one or more recommendations using the one or more user devices that have been already configured with the software applications, without the need for using the user interface 143 (For example, Screen C 205 in Scenario 1). Hence, the users are given additional privacy and flexibility in viewing the analysis report 109 and/or the one or more recommendations. Also, the additional costs incurred in deploying multiple user interfaces 143 at a retail store may be reduced by providing the one or more recommendations on the one or more user devices.

### Scenario 2: Decision Support System Deployed at an Electronic Retail Store.

FIG. 2C illustrates structure of the user interface 143 associated with the decision support system 101 deployed at an electronic retail store. As mentioned earlier, the structure of the user interface 143 may vary based on the nature of the one or more articles being selected by the user and the nature of the retail store. Accordingly, Screen A 201 of the user interface 143 at the electronic retail store may comprise a means for placing the one or more articles (electronic gadgets may be the articles in this scenario) selected by the user along with a display interface for displaying one or more information and/or recommendations to the user as represented by Screen B 203 in FIG. 2C.

As an example, consider that a user wants to buy a cell phone of brand ‘ABC-123’ which is available in the electronic retail store. Now, the user may place the selected cell phone on Screen A 201 of the user interface 143 using a support beam 211 comprised in Screen A 201. Thereafter, the receiving module 137 in the decision support system 101 may collect the one or more information related to the selected cell phone from the one or more first data sources 105, such as an information tag and/or an RFID tag attached to the cell phone. Similarly, the receiving module 137 may also retrieve one or more user related information 133 for understanding the interests and requirements of the user. As an example, the user may be most interested in purchasing a cell phone having a touch screen display and dual SIM facility at a price range of say, Rs. 6000. Now, as the user places the selected cell phone on screen A, the decision support system may display one or more information and specification of the cell phone on Screen B of the user interface. As shown in FIG. 2C, the one or more information displayed on Screen B may include, without limiting to, brand name of the cell phone, price range of the cell phone, one or more technical and/or non-technical features of the cell phone along with the ratings associated with the selected cell phone.

In an embodiment, recommendation module in the decision support system may also suggest/recommend one or more cell phones that are similar to the cell phone selected by the user on Screen B. As an example, the recommendation module may display a list of cell phones having one or more properties that are of at most interest to the user. In the above scenario, the one or more alternative cell phones suggested to the user may include a cell phone of brand ‘EFG-123’ with a similar price range, a cell phone ‘XYZ’ having a touch screen display and a cell phone of brand ‘ABC-456’ with a dual SIM facility as required by the user. Thus, the decision support system deployed at the electronic retail store provides an online-like retail shopping service to the user by enabling the user to browse through various alternatives and/or similar cell phones having one or more features of interest to the user.

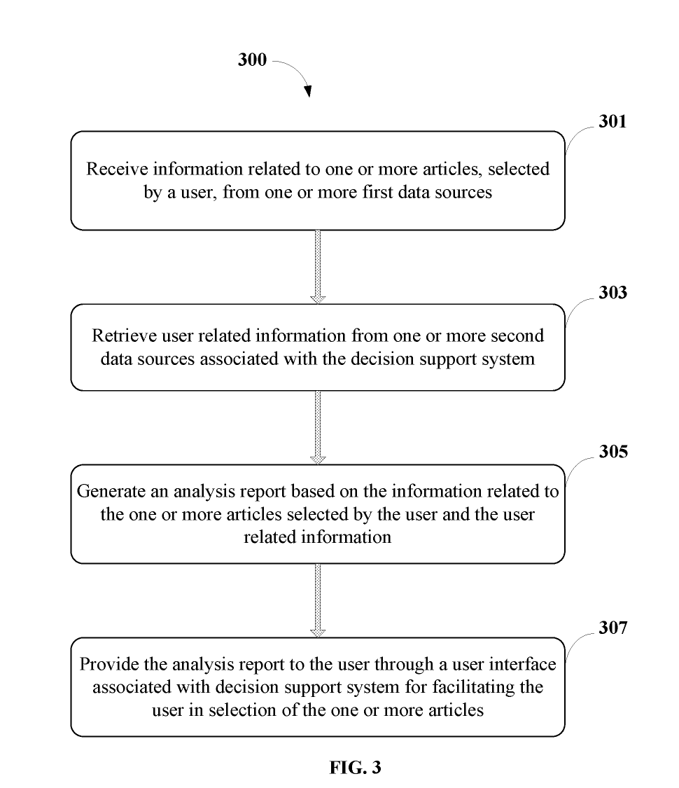

FIG. 3 shows a flowchart illustrating a method for facilitating the user in selection of the one or more articles in accordance with some embodiments of the present disclosure.

As illustrated in FIG. 3, the method 300 comprises one or more blocks for facilitating a user in selection of articles using a decision support system 101. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the decision support system 101 receives information related to one or more articles 131, selected by a user, from one or more first data sources 105. As an example, the information related to the one or more articles 131 comprises at least one of price of the one or more articles, properties of the one or more articles, feedbacks and ratings of the one or more articles. In an embodiment, the one or more first data sources 105 includes at least one of a barcode associated with the one or more articles, Radio Frequency Identification (RFID) tag associated with the one or more articles and social media networks.

At block 303, the decision support system 101 receives user related information 133 from one or more second data sources 107 associated with the decision support system 101. As an example, the user related information 133 comprises at least one of social media activities of the user, purchase history of the user and interests and personal details of the user. In an embodiment, the one or more second data sources 107 are updated at predefined time intervals based on purchase history of the user.

At block 305, the decision support system 101 generates an analysis report 109 based on the information related to the one or more articles 131 selected by the user and the user related information 133. In an embodiment, the analysis report 109 comprises one or more recommendations for facilitating the user in selection of the one or more articles. As an example, the one or more recommendations are at least one of information related to one or more articles 131 matching with the one or more articles selected by the user, information related to current trends and quality of the one or more articles selected by the user.

At block 307, the decision support system 101 the analysis report 109 to the user through a user interface 143 associated with decision support system 101 for facilitating the user in selection of the articles. The structure and use of the user interface 143 may vary based on the nature of the one or more articles and the nature of the retail store.

### Computer System

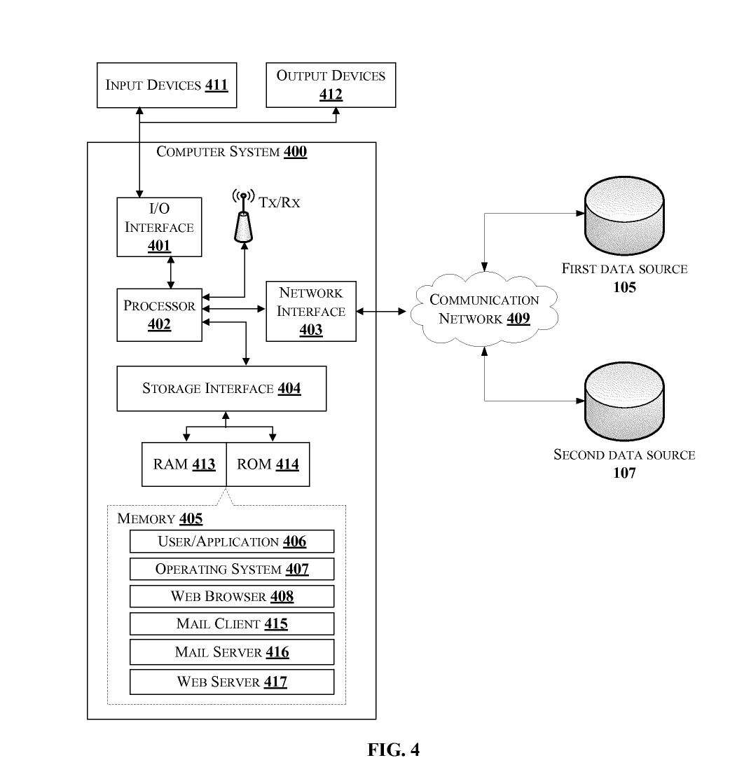

FIG. 4 illustrates a block diagram of an exemplary computer system 400 for implementing embodiments consistent with the present invention. In an embodiment, the computer system 400 may be the decision support system 101 which is used for facilitating a user in selection of one or more articles. The computer system 400 may comprise a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 401, the computer system 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with the first data source 105 and the second data source 107. The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc.) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application data 406, an operating system 407, web server 408 etc. In some embodiments, computer system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. User interface 406 may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the method of present disclosure facilitates a user in selecting one or more products/articles.

In an embodiment, the method of present disclosure enables the users to dynamically compare the articles, thereby helping the user to purchase a better article.

In an embodiment, the method of present disclosure helps the users to understand current trends with respect to the article, thereby preventing the users from purchasing an outdated and/or out-of-fashion article.

In an embodiment, the method of present disclosure provides one or more real-time recommendations to the users, thereby minimizing the total time taken by the users for purchasing the articles.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Retail environment |
| 101 | Decision support system |
| 105 | First data source |
| 107 | Second data source |
| 109 | Analysis report |
| 121 | I/O interface |
| 123 | Processor |
| 125 | Memory |
| 127 | Data |
| 129 | Modules |
| 131 | Information related to articles |
| 133 | User related information |
| 135 | Other data |
| 137 | Receiving module |
| 139 | Recommendation module |
| 141 | Other modules |
| 143 | User interface |
| 201 | Screen A |
| 203 | Screen B |
| 205 | Screen C |

We claim:

1. A method of facilitating a user in selection of articles in a retail environment, the method comprising:
receiving, by a decision support system, information related to one or more articles, selected by a user, from one or more first data sources;
retrieving, by the decision support system, user related information from one or more second data sources associated with the decision support system;
generating, by the decision support system, an analysis report based on the information related to the one or more articles selected by the user and the user related information; and
providing, by the decision support system, the analysis report to the user through a user interface associated with decision support system for facilitating the user in selection of the one or more articles.

2. The method as claimed in claim 1, wherein the information related to the one or more articles comprises at least one of price of the one or more articles, properties of the one or more articles, feedbacks and ratings of the one or more articles.

3. The method as claimed in claim 1, wherein the one or more first data sources includes at least one of a barcode associated with the one or more articles, Radio Frequency Identification (RFID) tag associated with the one or more articles and social media networks.

4. The method as claimed in claim 1, wherein the user related information comprises at least one of social media activities of the user, purchase history of the user and interests and personal details of the user.

5. The method as claimed in claim 1, wherein the one or more second data sources are updated at predefined time intervals based on purchase history of the user.

6. The method as claimed in claim 1, wherein the analysis report comprises one or more recommendations for facilitating the user in selection of the one or more articles.

7. The method as claimed in claim 6, wherein the one or more recommendations are at least one of information related to one or more articles matching with the one or more articles selected by the user, information related to current trends and quality of the one or more articles selected by the user.

8. A decision support system for facilitating a user in selection of articles in a retail environment, the decision support system comprising:
a processor; and
a memory communicatively coupled to the processor, wherein the memory stores processor-executable instructions, which, on execution, causes the processor to:
receive information related to one or more articles, selected by a user, from one or more first data sources;
retrieve user related information from one or more second data sources associated with the decision support system;
generate an analysis report based on the information related to the one or more articles selected by the user and the user related information; and
provide the analysis report to the user through a user interface associated with decision support system for facilitating the user in selection of the one or more articles.

9. The decision support system as claimed in claim 8, wherein the information related to the one or more articles comprises at least one of price of the one or more articles, properties of the one or more articles, feedbacks and ratings of the one or more articles.

10. The decision support system as claimed in claim 8, wherein the one or more first data sources includes at least one of a barcode associated with the one or more articles, Radio Frequency Identification (RFID) tag associated with the one or more articles and social media networks.

11. The decision support system as claimed in claim 8, wherein the user related information comprises at least one of social media activities of the user, purchase history of the user and interests and personal details of the user.

12. The decision support system as claimed in claim 8, wherein the instructions further causes the processor to update the one or more second data sources at predefined time intervals based on purchase history of the user.

13. The decision support system as claimed in claim 8, wherein the analysis report comprises one or more recommendations to facilitate the user in selection of the one or more articles.

14. The decision support system as claimed in claim 13, wherein the one or more recommendations are at least one of information related to one or more articles matching with the one or more articles selected by the user, information related to current trends and quality of the one or more articles selected by the user.
